(19) United States
(12) Patent Application Publication
(10) Pub. No.: US 2024/0351559 A1
(43) Pub. Date: Oct. 24, 2024

(54) TRAIN WASH

(71) Applicant: THE ORANGE TRAIN WASH LTD, Portsmouth, Hampshire (GB)

(72) Inventor: Martin WHITBREAD, Portsmouth, Hampshire (GB)

(21) Appl. No.: 18/686,843

(22) PCT Filed: Aug. 27, 2022
(86) PCT No.: PCT/IB2022/058045

§ 371 Date: Feb. 26, 2024

(30) Foreign Application Priority Data
Aug. 26, 2021 (GB) 2112247.8

(51) Int. Cl. B60S 3/00

(52) U.S. Cl. CPC B60S 3/006; B60S 3/002

(57) ABSTRACT

A train wash (1) for washing a train is described. The train wash comprises a water supply tank, for holding water for washing the train, a heater, for heating the water in the water supply tank, one or more water jets (14), for directing water from the water supply tank onto a side of the train, one or more rotatable brushes (4), for brushing against a region of the train onto which water is being or has been directed by the water jets, a water recovery tray, for location beneath the sides of the train, for collecting water running down the side of the train, a recirculation system, for recirculating water in the water recovery tray back to the water supply tank for reuse, and a filtration system, for filtering the water being recirculated from the water recovery tray to the water supply tank.

### TECHNICAL FIELD

The present invention relates to a train wash.

### BACKGROUND

Trains quickly become dirty, both internally and externally, during normal use. Internally, trains are generally returned to a dedicated depot at the end of the day for internal cleaning, stock replenishment, toilet emptying and minor maintenance. For external cleaning, in the UK trains are required to be cleaned on a regular basis, for example every three days. Existing train washing facilities take the form of dedicated enclosed structures through which the train passes (on rails) at scheduled times. These facilities are very large and thus difficult to site (they are too large to be sited at the same depot as used for cleaning the train internally). They are also very expensive, time consuming to use, and require amenities such as power, water supply and waste water disposal.

The present invention seeks to address some of these deficiencies, and to produce a train wash which is much more compact and easy to site, uses less water, and which is less expensive to construct and run.

### SUMMARY OF THE INVENTION

According to an aspect of the present invention, there is provided a train wash for washing a train, comprising:
a water supply tank, for holding water for washing the train;
a heater, for heating the water in the water supply tank;
one or more water jets, for directing water from the water supply tank onto a side of the train;
one or more rotatable brushes, for brushing against a region of the train onto which water is being or has been directed by the water jets;
a water recovery tray, for location beneath the side of the train, for collecting water running down the side of the train;
a recirculation system, for recirculating water from the water recovery tray back to the water supply tank for reuse; and
a filtration system, for filtering the water being recirculated from the water recovery tray to the water supply tank.

Preferably, a deioniser is provided, for deionising the water being recirculated from the water recovery tray to the water supply tank. By using de-ionised water, this collects dirt and runs easily off of the side surface of the train, with no need for added chemicals, thereby reducing pollution.

Preferably, one or more air jets is provided, for blowing water down the side of the train and into the water recovery tray.

While existing train carriage washing machines can use 15,000 litres of water a day, the proposed apparatus may be designed to use only 260 litres of water per day, because the water is recycled.

The water jets may direct the water in the form of liquid water, steam or a combination of both.

The train wash may comprise a first pump, for pumping the water from the water supply tank through the water jets/nozzles.

The recirculation system may comprise a dirty water tank, and a second pump for pumping the water from the water recovery tray to a dirty water tank.

The recirculation system may comprise a third pump for pumping the water in the dirty water tank through the filters and into the water supply tank.

The train wash may comprise a controller, configured to control the heater to adjust the temperature of water in the supply tank from a maintenance temperature (above freezing point, to avoid the water freezing in cold weather) to an operating temperature (heated to a suitable temperature, higher than the maintenance temperature, for cleaning the train) in response to a determination that a train to be cleaned will arrive at the train wash in a predetermined period of time. The determination may be based on scheduling information (train timetables) and/or live position (e.g. GPS) information of the trains.

More generally, the controller may maintain the water in the water supply tank at a first predetermined temperature (to prevent freezing) while the train cleaner is not in use. The first predetermined temperature may be between 3 degrees and 40 degrees, preferably between 10 degrees and 20 degrees and still more preferably approximately 15 degrees. The controller is then operable to further heat the water in the water supply tank to a second predetermined temperature to actually carry out cleaning, the second predetermined temperature being much higher (approaching boiling point, or at or above boiling point if steam is to be expelled from the nozzles/jets onto the side of the train) than the first predetermined temperature. By retaining the water in the water supply tank at a first predetermined temperature, and in particular above freezing point, the water in the tank will not freeze and cause damage to the tank (and make it much harder to bring the tank up to temperature on demand). The second predetermined temperature is selected to maximise cleaning efficiency, prevent damage to the train finish and seals, and minimise the likelihood of viral or bacterial presence within the water.

At least the water jets, rotatable brushes and air jets may be disposed on a movable cleaning head, movable (with respect to a base unit of the machine) between a cleaning position for engaging the side of a train and a resting position permitting trains to pass untouched.

The train wash may comprise a controller which is responsive to the approach of a train to be cleaned to move the cleaning head towards the track to engage the side of the train. The approach of the train may be detected using an electronic (e.g. RFID) reader which detects an electronic (e.g. RFID) tag disposed on a train or carriage. The controller may log that a particular train and/or carriage has been cleaned based on an identifier of the electronic tag read by the electronic reader.

A train washing system may be provided, comprising a pair of train washes according to the above, disposed to either side of a track. The train washes may be disposed directly opposite each other, and the water recovery tray may then be shared between both train washes. Alternatively, the two train washes may be offset from each other, with their own respective water recovery trays. The water recovery tray/pan capacity is preferably greater than required to cope with typical rainfall for the area of installation, such that no outlet/overflow valve and wastewater disposal/drainage facilities are required.

Preferably, the rotatable brushes are rotated in a direction opposing the direction of travel of the train. In other words, the portion of the brush coming into contact with the train is travelling in the opposite direction to the train at its point of contact.

The air jets may be provided as an air blade, for example formed by a longitudinal slot in a conduit.

In most implementations, the train cleaner cleans only the sides of the train, and not the top or wheel region. This is because the sides of the train are the only parts routinely visible to the public, and contain the windows (in relation to which cleanliness is apparent both from outside and within the train). Specifically, the top of the train can only be seen from overhead bridges, while the wheels of the train are generally concealed beneath the platform. Further, the top of some trains are heavily electrified, raising safety concerns, while cleaning the wheels presents additional challenges (such as damage to brushes). By limiting to cleaning the sides of the train, the size, complexity and cost of the train cleaner may be greatly reduced.

In other implementations, the top of the train and/or the wheels of the train may be washed. For example, the roof of diesel trains can be more safely cleaned due to the lack of electrified components.

The train cleaner requires only a small amount of space alongside (each side) of a train track. It can thus be conveniently placed at the entrance to or within a depot, at the run up to a train platform, or anywhere else on a short straight portion of track.

Because the train cleaning heads retract away from the tracks, trains which are not due to be cleaned can pass by at speed.

For the purposes of cleaning, the train is required to pass by the train cleaner at a relatively slow speed, preferably approximately 4 km/h. At this speed, it will take approximately 4 minutes to clean an 8 carriage train.

The brushes are softer than those used for a car wash, and are preferably unable to knot.

### BRIEF DESCRIPTION OF THE DRAWINGS

Embodiments of the present invention will now be described by way of example only with reference to the accompanying drawings where like parts are provided with corresponding reference numerals and in which:

FIG. 1 schematically illustrates a 3D external front view of a train cleaning apparatus;

FIG. 2 schematically illustrates a 3D external rear view of the train cleaning apparatus, with cover removed to reveal internal components;

FIG. 3 schematically illustrates a plan view of the train cleaning apparatus, again with cover removed;

FIG. 4 schematically illustrates a further view in which a cleaning head portion of the train cleaning apparatus is shown separately from a base portion of the train cleaning apparatus; and

FIG. 5 schematically illustrates a plan schematic view of a train cleaning system provided trackside, including two train cleaning apparatuses and associated equipment.

### DETAILED DESCRIPTION

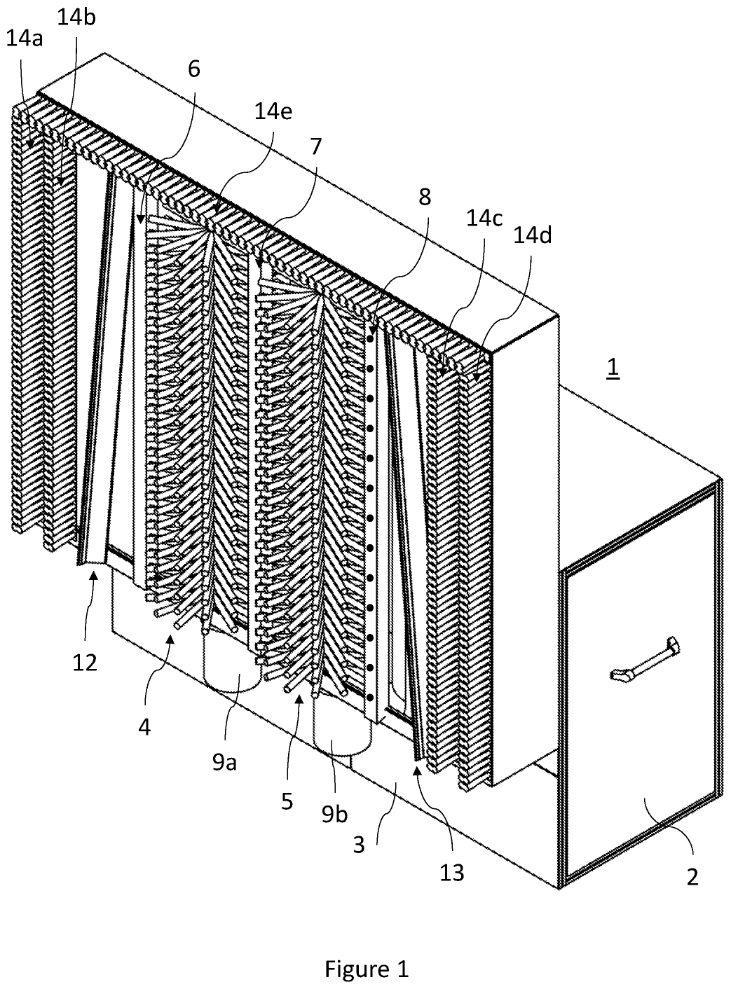

Referring to FIG. 1, a train cleaning apparatus 1 can be seen to comprise a base unit 2 and a cleaning head 3. The base unit 2 is positioned on the ground along the side of a train track. The machine will be mounted trackside and will generally require installation of a concrete base if not already present for mounting purposes along with electricity and water. The cleaning head 3 is movably mounted to the base unit 2, so that it can be brought into engagement with a side of a train as the train passes along the track and past the cleaning apparatus 1, and moved away from the track to allow other trains (not due to be cleaned) past without coming into contact with the cleaning head 3.

Referring briefly to FIG. 4, the manner in which the cleaning head 3 is mounted to and moved with respect to the base unit 2 is shown. In particular, four linear actuators 11a, 11b, 11c, 11d driven by motors are provided which are mounted on a frame of the base unit 2 and attached at one end to a body of the cleaning head 3. These enable the cleaning head 3 to be extended and withdrawn approximately 200 mm, enabling in use full engagement with the side of a train, and out of use for the cleaning heads to be retracted to a safe distance to allow passage of trains without contact with the cleaning head 3. In FIG. 4 the linear actuators 11a, 11b, 11c, 11d are shown to be positioned at two top corner positions of the base unit 2, and at two mid side positions of the base unit 2, but it will be appreciated that a different number of and positioning could be used for the linear actuators 11a, 11b, 11c, 11d. In this way, the whole cleaning head unit 3 will move forward to be in the correct position for cleaning and retract after. It will be appreciated that alternatives may be provided. For example, the entire unit 1 (base unit 2 and cleaning head 3) could be mounted on a movable platform (on bearings), and thus moved into and out of position as required.

Returning to FIG. 1, the cleaning head 3 can be seen to comprise a first vertical brush roller 4. The brush used for the roller is of a type and material typically used to polish apples in a packaging environment, that is-softer than those typically used for a car wash or a train wash. As a result, the brush roller will not damage the vinyl wrap on the train body. A second vertical brush roller 5, of the same form and material as the first brush roller 4, is also provided. It will be understood that a single roller could be used (although can be expected to result in inferior performance), or a greater number of rollers could be provided. A first vertical spray bar 6 is disposed to one side of the first vertical brush roller 4, a second vertical spray bar 7 is disposed between the first vertical brush roller 4 and the second vertical brush roller 5, and a third vertical spray bar 8 is disposed to the other side of the second vertical rush roller 5. Again, a greater or fewer number of spray bars could be provided, but three provides a good level of performance when positioned in this way relative to two rollers. Each of the spray bars 6, 7, 8 are provided with a series of (for example 20) apertures or nozzles along its length, on a (front) side thereof facing the train body in use. The spray bars 6, 7, 8 each have a rectangular cross section as shown, but could equally be provided with a circular or other cross section. Example apertures are shown on the third spray bar 8 in FIG. 1, but in the interests of clarity are not shown on the first and second spray bars 6, 7. In use, the first, second and third vertical spray bars 6, 7, 8 direct clean water onto the side of the train through the apertures (or nozzles), while the first and second vertical brush rollers 4, 5 are rotated across the wet train surface to clean dirt from it. To achieve this, water is pumped into the spray bars 6, 7, 8 and, causing it to be expelled through the apertures.

The first vertical bush roller 4 is driven to rotate by a first drive motor 9a, disposed beneath the first vertical brush roller 4 on the cleaning head 3. The second vertical bush roller 5 is driven to rotate by a second drive motor 9b, disposed beneath the second vertical brush roller 5 on the cleaning head 3. The first and second drive motors 9a, 9b may each be a 2.2 kw motor operating at 1300 rpm, which will allow for alterations to brush speed of 375 rpm-1300 rpm after installation to achieve the best result. The first and second vertical brush rollers 4, 5 and the first, second and third vertical spray bars 6, 7, 8 are referred to herein as washing elements. The distribution of water from the spray bars need not necessarily be even, but may instead be targeted to horizontal positions, and at angles, which require the most water to provide an effective clean. The jets of water may be shaped, for example as a fan or a cone. This can be achieved by the shape of the apertures in the front of the spray bars (which may for example be circular, oval or slot shaped), or in the alternative by way of shaped nozzles mounted on the front of the spray bars 6, 7, 8.

The shape and distribution of the jets will generally be fixed, defining a compromise between different train types. Alternatively, the jets may be adjustable to cater for different train types. While the jets of water may themselves displace some dirt, they are principally to provide water to where it is needed, to facilitate the brushes 4, 5 in removing dirt from the side of the train.

The brushes 4, 5 may be a pair of coiled roller brushes with 40 mm diameter stainless steel shafts of 2.3 m in length×600 mm to cover from the cant line to the footplate of the doors. High quality materials are used for the brushes, to minimise damage to the vinyl livery wrapping used on train carriages, while ensuring a high standard of cleaning performance. Two dovetail lag brushes may be used to ensure central section contains the water and air during the clean with enough space to ensure closure around the Train Driver Only Operated cameras. The brushes 4, 5 are set to rotate against the direction of travel of the train, which has been found to improve the quality of the clean. The direction of rotation of the brushes 4, 5 can be reversed to be able to handle trains passing by the train cleaner from both directions.

To either side of the washing elements there is provided an angled air blade 12, 13, it being angled to be closer to the washing elements at the top than at the bottom. Each air blade directs a blade of air against the train from a longitudinal slot, forcing water on the (now clean) sides of the train downwardly, to drop from the bottom of the side of the train to be collected. Each of the air blades 12, 13 may take the form of a bar or pipe with a longitudinal slot provided in its front face (towards the train to be cleaned), in order to expel a shaped blade of air. Alternatively, a series of shorter slots may be provided to define a series of blades. Less optimally, air may be expelled in a differently shaped series of jets. The air blades/driers are provided both to the left and right of the cleaning elements to allow for switching dependent on the direction of the train entering the depot. It will be appreciated that only one of the two air blades is required to be used for a particular clean.

To either side of the air blades 12, 13 (to either side of the cleaning head 3), and along the top of the cleaning head 3, a set of seals 14a, 14b, 14c, 14d, 14e is provided to prevent or at least inhibit dirty water from escaping a region defined between the cleaning head 3 and the side of the train. In particular, two parallel seals 14a, 14b are provided at one side of the cleaning head 3, two parallel seals 14c, 14d are provided at the other side of the cleaning head 3, and one seal 14e (perpendicular the other seals) is provided along the top of the cleaning head 3. The seals take the form of brushes which may deform resiliently against the side of the train to create a seal without damaging the surface of the train. The use of the seals 14a-e reduces water losses, and keeps the surrounding area clean.

In an alternative arrangement, a different drying method may be provided, such as a centrifugal blower. Similarly to an air blade, this will remove water from the surface of the carriage by forcing the air downwards to allow the dirty water to be blown under the train and into the track pan ready for capture and recycling.

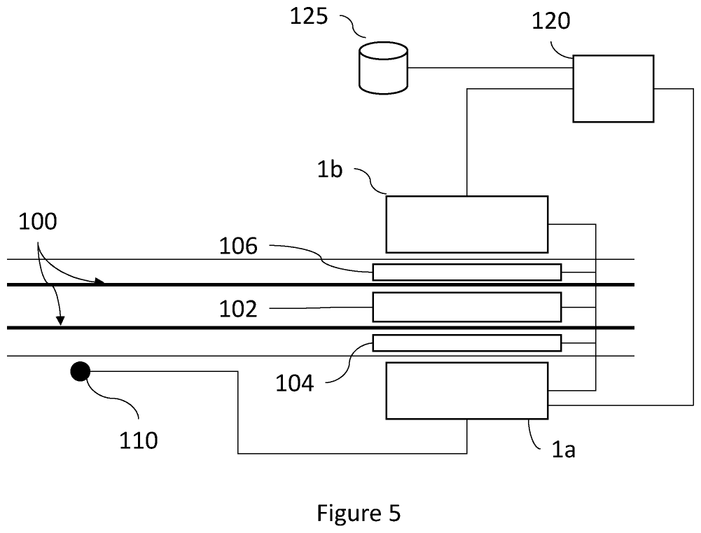

One or more track pans (not shown in FIG. 1, but shown in FIG. 5 described below), is provided below the train, preferably one between the track rails, and another to the side of the track rail proximate the cleaning apparatus 1. These collect the dirty water which runs down (or is driven down by the air blade 12, 13), for reuse by the cleaning apparatus 1.

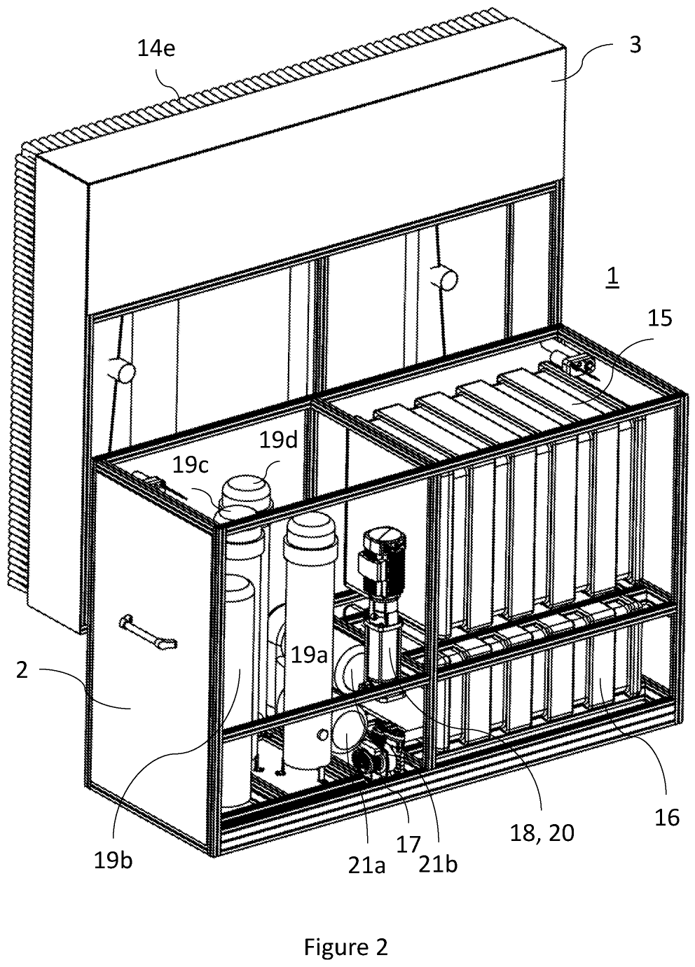

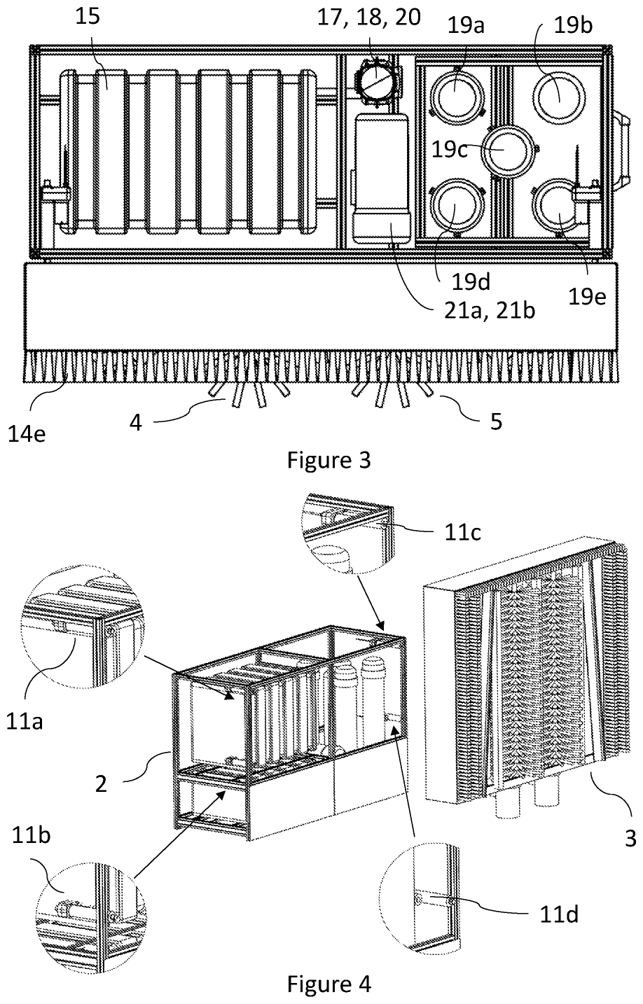

Referring now to FIGS. 2 and 3, the base unit 2 is shown with internal parts exposed. The base unit 2 can be seen to comprise a clean water tank 15, a dirty water tank 16, a first pump 17 for pumping water collected in one or more track pans/water recovery trays into the dirty water tank 16, a second pump 18 for pumping water in the dirty water tank 16 through a set of five filters 19a, 19b, 19c, 19d, 19e and into the clean water tank 15, and a third pump 20 for pumping water from the clean water tank 15 into and through the water jet spray bars 6, 7, 8. A pair of blowers 21a, 21b is provided, for drawing in air from outside the base unit and driving it out through the air blades 12, 13. While two blowers are provided in the present embodiment, one for each air blade (and thus only one blower will be used in a particular clean, depending on the direction the train passes the apparatus 1), in an alternative implementation a single blower may be provided with a switch valve, to selectively drive air through the two air blades 12, 13. The blowers 21a, 21b may each utilise an aluminium impeller with a hardened steel drive pulley set on anti-vibration feet. This may be provided to achieve a sound level of around 82 dB, which may be further dampened by providing it in an insulated box.

The clean water tank 15 may for example have a volume of approximately 900 litres, while the dirty water tank 16 may for example have a volume of approximately 500 litres. The clean water tank 15 may in this way contain enough water to clean two trains of carriages. As a result, heating the water to the required temperatures is economically and environmentally viable. Between train washes, the clean water tank 15 can be topped up from the dirty water tank 16 (via the filters, which means that recirculation cannot be carried out in real time during cleaning), with the dirty water tank 16 being replenished from water captured beneath the train carriage in the track pan during washing. Each tank is preferably insulated for example with 100 mm of rock wall insulation on all sides, top and bottom. This reduces the amount of energy required to keep the water at a desired temperature (and helps prevent freezing). In addition, the clean water tank 15 (and preferably the dirty water tank 16) is provided with heating elements, which can be switched on and off (or variably controlled) to regulate the temperature of the water in the tank(s). The water in the dirty water collection tank 16 and/or clean water tank 15 will be kept at 10 to 15 degrees (when the machine is not currently in use) to ensure it can be used in all weathers, since current train washes are not able to be used at 3° C. or lower.

The main tank 15 will feed the spray bar at 85° C., which will ensure the best possible clean and minimise any chance of legionnaires, which is killed at 60° C. More generally, the water temperature may be anywhere in the range of 40° C. to 100° C. Preferably greater than 60° C. to kill bacteria such as legionnaires. Still more preferably approximately 85° C. The greater amount of electrical power required to raise the temperature beyond this may not be justified.

The five filters 19a, 19b, 19c, 19d, 19e are provided in a series configuration (in this order), representing 5 stages of water treatment. Generally, the first three stages remove successively smaller debris and particulates, the fourth stage removed hydrocarbons, very find dust and oils, and the fifth stage deionises the cleaned water.

### Stage 1-Large Particulate Reduction (Filter 19a)

This filter employs a stainless steel housing and bag filtration technology to reduce larger particulates that may be washed from the trains. Stage 1 is set at 100 um, allowing the bag to void and remove very large particulate like leaf debris, whilst the matrix of the bag traps smaller particles as they pass through. Size 2 bags offer high dirt holding coupled with low pressure drop making them suitable for the first stage.

### Stage 2-Targeted Particulate Reduction Prior to Cartridges (Filter 19b)

Still utilising Stainless Steel housings and bag filters, stage 2 utilises a dual layer bag where pre-filtration of the water passes through a media layer before being filtered by the targeted level of filtration. This prolongs the life of the final layer by protecting it from any larger particulate that may have bypassed the first layer. Set with 25 um with a 100 um pre-filtration layer, this filter will now be reducing particulate smaller than can be seen with the naked eye.

### Stage 3-Cartridge Filtration Prior to Hydrocarbon Reduction (Filter 19c)

Set at 5 um the filters are configured in a 5×40″ housing giving excellent fine particulate reduction of up to 85%. The SPECTRUM PSP is widely used in applications where high levels of particulate efficiency is required. The PSP traps the particulate within its graded density ensuring minimal bypass prior to the hydrocarbon reduction stage.

### Stage 4-Hydrocarbon Reduction (Filter 19d)

As there could be a presence of hydrocarbons, brake dust and oils, the stage 4 filter is provided. The cartridges for this filter have the ability to hold 3 times their weight in some hydrocarbons. These are also housed in the same housing as the above-described filters to maintain consistency.

### Stage 5-Di Resin (Filter 19e, or De-Ioniser)

This is a deionising pressure unit with an ion-exchange resin in, such that the set of filters finally outputs de-ionised water after being filtered and before finally being pumped into the main water tank. Stage 5 uses an SRDI resin which has the ability to reduce up to 30,000 TDS per litre of resin within a vessel. This will be used to make up the initial 500 to 750 litres of water per day.

The filtration system described above will also allow tap water to be used to top up the water should rainfall and recycling result in a shortfall, which could either pass through all five filters 19a-e, or be inputted directly through the stage 5 (deionising) filter 19e to be deionised ready for use.

The first pump 17 (sump pump from the track-pan back to the (preferably 200 L to 500 L) dirty water tank 16), the second pump 18 (pump to force water back through the filtration at 15 lpm into the main 750 L-900 L clean water tank) and the third pump 20 (to drive water from the clean water tank 15 through the water jet bars 6, 7, 8) may take various forms, either the same, or different. Preferably, a single magnetically driven multi-stage centrifugal pump is used to implement the three different pumps as a single unit. The third pump 20 is preferably to be rated to 100 LPM @ 1 Bar×2 for each water jet bar.

To clean both sides of a train, one pair of the train cleaning machines may be positioned to either side of the track, on each road in a typical set of sidings. Referring to FIG. 5, two train cleaning machines 1a, 1b are provided in this way, one each at either side of a track 100. Three track pans are provided between the two cleaning machines 1a, 1b. In particular, a first track pan 102 is provided between the two rails of the track 100, a second track pan 104 is provided between one of the rails and one of the cleaning machines 1a, and a third track pan 106 is provide between the other of the rails and the other of the cleaning machines 1b. When the trains are being cleaned, water dropping from the sides of the train is collected by the first, second and third track pans 102, 104, 106. The first pump 17 referring to above pumps the captured dirty water from the track pans into the dirty water tanks 16 of each of the cleaning machines 1a, 1b via a pipe or other conduit (these are shown in FIG. 5, connecting the track pans to the machines 1a, 1b. In some implementations the first track pan 102 may not be provided, on the assumption that most of the water dropping down from the sides of the train will fall outside the region between the two rails of the track 100.

An RFID reader 110 is provided a short distance upstream (in the direction the train approaches from) of the cleaning machines 1a, 1b. This is able to detect the presence of an RFID tag provided on an inbound train, shortly before it reaches the cleaning machines 1a, 1b. This alerts the cleaning machines 1a, 1b that they need to prepare for cleaning by moving (their cleaning heads 3) inwardly towards the track 100. Preferably each carriage of the train is provided with an RFID tag, enabling the system to know when the last train carriage has passed, after cleaning of which the cleaning machines 1a, 1b may move (their cleaning heads 3) to their at rest positions away from the track 100. The cleaning machines 1a, 1b are in communication with a controller 120, which controls the operation of the cleaning machines 1a, 1b (and other cleaning machines elsewhere on the train network). The controller 120 may be a general-purpose computer with suitable software and which is connected to a local control system of each of the cleaning machines 1a, 1b. The controller 120 has access to a scheduling database 125 indicating when trains are due to approach and utilise the cleaning machines 1a, 1b. The controller 120 is able to trigger the cleaning machines 1a, 1b to prepare for an inbound train, based on scheduling information in the scheduling database 125. Live position information (for example using GPS) of inbound trains may also be used. In any case, a predetermined time in advance of the arrival of a train at the cleaning machines 1a, 1b, the water in the clean water tank 15 is heated from the maintenance temperature to the operating temperature. The predetermined time is selected to provide sufficient time for this heating to take place before arrival of the train. As a result, the water does not need to be maintained at the higher operating temperature at all times, thus saving energy. Water is only maintained at the lower maintenance temperature, to prevent freezing and cold damage to the machines 1a, 1b.

Water pumped from the trays 102, 104, 106 into the second tank (dirty water) can be transferred more quickly than the water from the second tank to the first tank, since the former does not need to pass through the filters (which severely limit throughput). The machine will therefore use filtered, heated water, which is applied to the train bodyside through the three spray bars with (in this example) 20 jets on each set to the correct angles to apply water to the side of the train along with two rotating brushes. The machine is a single stage machine, and one machine is designed to clean one side of the train; this means that a pair of machines will be required for both sides of a train, as per FIG. 5.

A water collection system, in the form of track pans/recovery trays, pipework and pumps, will recover water from either the body side or the underneath of the train through the track pan system, and this water is recirculated and filtered for re-use. When not in use the machine is required to retract or move clear of the trackside to permit movements of other types of rolling stock.

The design uses reduced quantities of water compared to existing train washes, and combined with water collection and filtration aims to recycle all water collected from the cleaning operation.

The machine footprint is extremely small in comparison to a traditional train washing plant as the machine is approximately 3 m×1.2 m and it is envisaged that this may permit heated water cleaning machines to be in multiple positions on depot.

The machine can be a stand-alone and removable but fixed in location on either side of the road in the depot to clean each train as it rests for its normal internal clean and refilling of supplies.

In this way, it would be possible for every carriage to be cleaned every day, in situ of where the train will be for internal cleaning and restocking, rather than being required to take the train to a separate dedicated washing facility.

As the train arrives or departs at the speed of 4 to 6 km per hour the exterior of the train will be washed with hot water with two brushes and three jet bars and with water forced downwards and off the train into a track pan which will then collect and recycle the water before being pumped into filtration for the purpose of reuse after de-ionising and reheating.

A Typical 8 carriage train will take just under 4 minutes to clean and use 400 Litres of water with an expected recycling of 360 Litres showing a net loss of 40 litres. The recycling at 15 LPM would take 24 minutes for it to be collected and filtered and deionised ready for reuse. It is for this reason that the clean water tank should contain sufficient water for multiple train cleans, since the water used on the first train may not have been replenished (and reheated) by the time of arrival of the subsequent train.

The system will use very hot (e.g. 85° C.) de-ionised water with no chemicals being used. By using deionised water there is a reduced risk of stains being left on the surface. The system will not require drainage as the unit is self-sufficient, but a dump valve may be provided to service the tanks and change element.

An ultraviolet light may be provided within the tank, serving to kill bacteria in the case that the temperature drops below 60° C.

Sensors are preferably provided on all pumps and heaters to track pressure and temperature respectively, and the clean and dirty water tanks provided with level sensors to track the amount of water present in the tanks, thereby allowing real time information to be displayed at remote computer locations. The status of the filters may also be monitored to ensure that these can be replaced/cleaned when required. The above will enable remote monitoring of all temperatures and water usage and savings to accurately show carbon saving figures and ensure maintenance as and when required. This in turn allows for lower cost of maintenance, better resource utilization, less downtime, reduced energy consumption, fewer maintenance bills and greater predictability. This will also give evidential proof that a cleaning regime is in place allowing time and day to be verified for every carriage (identified by RFID).

The controller 120 may be connected to the Internet/World Wide Web, to provide real time heath and usage reporting of the train cleaning apparatus. In particular, the information reported may include system availability (train cleaner active, pre-heated and ready to clean or not for example), and the operational status of system components, utilities (electrical power and water), and peripherals (sensors and communications for example).

The connection to the Internet may also be used to obtain information on train tracking (where trains are on the network, the direction they are travelling, a time at which they would be expected to arrive at the cleaning apparatus location). Operation of the cleaning apparatus may rely on data obtained over the Internet, in particular by enabling the cleaning apparatus/system to known when to operate and how to operate, according to the vehicle type, class and direction of vehicle. In particular, the vehicle type and class may be used to determine how long the apparatus needs to be operating for (based on a particular vehicle set speed past the cleaning apparatus), while the direction of the vehicle (past the cleaning apparatus) may be used to control the direction of rotation of the brushes/rollers.

The controller 120 may provide a validated reporting process, resulting in a history of every vehicle clean, including vehicle identification and vehicle cleaning quality. The reporting may include how much water and electricity was involved in a particular cleaning operation, how much water was recycled, and in some cases an overall carbon saving associated with the cleaning operation compared with baseline conventional train cleaning operations. This can be use to carry out performance analysis compared with existing carriage wash machines, per vehicle.

The controller is able to understand vehicle speed and direction locally, and may use this information to control the duration of operation, and direction of the brushes. If the vehicle does not move for a certain period (for example 6 seconds), the brushes will retract to prevent damage to the vehicle finish. The driver of the train may be provided with an indication of when the train has passed the cleaner, permitted them to speed up to normal speeds.

In summary, the train cleaning machine described above uses filtered, heated water (or steam), which is applied to the train bodyside through blades/spray bars offered to the side of the train along with rotating brushes. The machine is designed to be single stage (only one pass of the train past the machine is required to complete cleaning), and one machine is designed to clean one side of the train; this means that a pair of machines will be required to clean both sides of a train. A water collection system recovers water from either the body side or the underneath of the train, and this water is recirculated and filtered for re-use. When not in use the machine, or part thereof, will retract from the trackside to permit movements of other types rolling stock (not being cleaned). The present design uses reduced quantities of water compared to existing train washes and combined with water collection and filtration it is possible to recycle all water collected from the cleaning operation. The machine will be mounted trackside and may require installation of a concrete base for mounting purposes along with electricity and water supplies.

Certain implementations of the present technique may be applied to other vehicles, such as buses.

1. A train wash for washing a train, comprising: a water supply tank, for holding water for washing the train; a heater, for heating the water in the water supply tank; one or more waterjets, for directing water from the water supply tank onto a side of the train; one or more rotatable brushes, for brushing against a region of the train onto which water is being or has been directed by the water jets; a water recovery tray, for location beneath the sides of the train, for collecting water running down the side of the train; a recirculation system, for recirculating water in the water recovery tray back to the water supply tank for reuse; and a filtration system, for filtering the water being recirculated from the water recovery tray to the water supply tank.

2. A train wash according to claim 1, comprising: a deioniser, for deionising the water being recirculated from the water recovery tray to the water supply tank.

3. A train wash according to claim 1, comprising: one or more air jets, for blowing water down the train and into the water recovery tray.

4. A train wash according to claim 1, wherein the waterjets direct the water in the form of liquid water, steam or a combination of both.

5. A train wash according to claim 1, comprising a first pump, for pumping the water from the water supply tank through the water jets/nozzles.

6. A train wash according to claim 1, wherein the recirculation system comprises a dirty water tank, and a second pump for pumping the water from the water recovery tray to a dirty water tank.

7. A train wash according to claim 6, wherein the recirculation system comprises a third pump for pumping the water in the dirty water tank through the filters and into the water supply tank.

8. A train wash according to claim 1, comprising one or more air jets for driving water down the side of the train for collection by the recirculation system.

9. A train wash according to claim 1, comprising a controller, configured to control the heater to adjust the temperature of water in the supply tank from a maintenance temperature to an operating temperature in response to a determination that a train to be cleaned will arrive at the train wash in a predetermined period of time.

10. A train wash according to claim 1, wherein at least the waterjets, rotatable brushes and air jets are disposed on a movable cleaning head, movable between a cleaning position for engaging the side of a train and a resting position permitting trains to pass untouched.

11. A train wash according to claim 10, wherein the train wash comprises a controller which is responsive to the approach of a train to be cleaned to move the cleaning head towards the track to engage the side of the train.

12. A train wash according to claim 11, wherein the approach of the train is detected using an electronic reader which detects an electronic tag disposed on a train or carriage.

13. A train wash according to claim 11, wherein the controller logs that a particular train and/or carriage has been cleaned based on an identifier of the electronic tag read by the electronic reader.

14. A train wash according to claim 1, wherein the water recovery tray capacity is greater than required to cope with typical rainfall for the area of installation.

15. A train wash according to claim 1, wherein the rotatable brushes are rotated in a direction opposing the direction of travel of the train.

16. A train wash according to claim 1, wherein the air jets are provided as an air blade.

17. A train washing system, comprising a pair of train washes, disposed to either side of a track, each of the pair of train washes comprising:
a water supply tank, for holding water for washing the train;
a heater, for heating the water in the water supply tank;
one or more waterjets, for directing water from the water supply tank onto a side of the train; one or more rotatable brushes, for brushing against a region of the train onto which water is being or has been directed by the water jets;
a water recovery tray, for location beneath the sides of the train, for collecting water running down the side of the train;
a recirculation system, for recirculating water in the water recovery tray back to the water supply tank for reuse; and
a filtration system, for filtering the water being recirculated from the water recovery tray to the water supply tank.

18. A train washing system according to claim 17, wherein the train washes are disposed opposite each other, and the water recovery tray is shared between both train washes.
